(19) United States
(12) Patent Application Publication
(10) Pub. No.: US 2020/0008343 A1
(43) Pub. Date: Jan. 9, 2020

(54) RADIAL SUCTION-TYPE SEED METERING APPARATUS

(71) Applicant: Benjamin DALLA ROSA, Maringá (BR)

(72) Inventor: Benjamin DALLA ROSA, Maringá (BR)

(21) Appl. No.: 16/502,069

(22) Filed: Jul. 3, 2019

(30) Foreign Application Priority Data
Jul. 3, 2018 (BR) 10 2018 013667-4

(51) Int. Cl. A01C 7/04; A01C 7/20

(52) U.S. Cl. CPC A01C 7/046; A01B 79/005; A01C 7/20

(57) ABSTRACT

“RADIAL SUCTION-TYPE SEED METERING APPARATUS”, comprising a seed metering apparatus for the distribution of farming seeds, coupled to agriculture machines named planters. The mentioned seed metering apparatus is activated by an electric motor and/or any other mechanical or hydraulic system that rotates the seed distribution disc carrying the seeds located in the inner part of the seed reservoir with the aid of a central turbine, where the air suction is carried out through ducts between the turbine and the seed meter, generating a negative pressure in the meter inner part. The seeds are stored in the radial disc outer part holes for seed distribution and, by getting to the exact point perpendicularly to the soil, the vacuum generated is interrupted by the turbine through the elastic pulley located inside the disc, so that the seeds are released due to gravity force through a duct that drives the seeds to the holes by the double disc of furrow opener discs. Finally, the holes are sealed through closing and gauge wheels for the perfect seed germination.

### RELATED APPLICATION

This application claims the benefit of priority of Brazilian Patent Application No. BR 10 2018 013667-4 filed on Jul. 3, 2018, the contents of which are incorporated herein by reference in their entirety.

### FIELD AND BACKGROUND OF THE INVENTION

The present invention generally relates to an apparatus used in agricultural planting machines, more particularly to a planter, sower and fertilizer seed apparatus.

The mentioned radial suction-type seed metering apparatus is distinguished for having low friction level with the radial disc and for perfectly sealing holes as the seeds are reliably released from the seed meter. A seed organizer having an easily adjustable system, a radial disc replacement system as well as a multiple coupling system are other advantages of the present invention.

Agriculture is a Latin-originated word and, according to its etiological definition, it is the activity for the soil cultivation in order to produce vegetables for humans and/or livestock.

The beginning of agriculture is estimated to be dated before the development of the writing, being very difficult to determine exactly how it had advanced before the Ancient History. However, agricultural practices has allowed the improvement of food offer in periods when humans' provisions consisted mostly of hunting.

With the humanity's technological advance, agricultural activity has brought a number of benefits related to its development, considering that it was carried out in a rudimentary way and exclusively by manual labor. Such activity began to be developed by using apparatus and systems.

Agricultural activity is currently in an outstanding stage in terms of development, known as precision agriculture. Precision agriculture is the integrated management of both information and technology, based on the concept that its performance is influenced by variability of space and time.

By adopting precision agriculture, the agriculture sector has developed a series of machines and apparatus aiming to improve efficiency on planting and harvesting, one of those apparatuses named planter, also known as seeder.

The planter is an agriculture machine that, whenever coupled to a tractor, can carry out sowing and culture planting operations. One of the most important part of an agricultural planter is the seed meter, responsible for the density and distribution of sowing in plantation area, affecting the sowing quality directly.

There are many seed meter models, most of them having axial suction-type feature; however, those seed meters have technical problems related to the high level of friction on the seed disc. Besides, conventional seed meters do not completely seals the holes as the seeds are released from the seed meter.

Axial suction-type seed meters require flat scrappers that usually apply friction to the seed disc in order to stop negative pressure suction, since the scrappers are static and the disc is dynamic. Likewise, the seeds fall sideways experiencing friction and, consequently, are deviated from the correct route compromising the seed plantation precision.

Mechanical meters could be considered as an option to the axial suction-type seed meters, currently falling into disuse; however such models lack high productivity since they do not ensure uniform row spacing distribution of seeds, presenting failures or seeds double.

### SUMMARY OF THE INVENTION

The present invention provides radial suction-type seed metering apparatus.

In a preferred embodiment of the radial suction-type seed metering apparatus in accordance with the present invention, an internal friction is reduced and holes are perfectly sealed as the seeds are released from the seed meter.

A further preferred embodiment of the radial suction-type seed metering apparatus in accordance with the present invention is to provide an adjustable system to its seed organizer.

Finally, another preferred embodiment of the radial suction-type seed metering apparatus in accordance with the present invention is to provide a fast and easy-to-operate apparatus for use on several type of seeds.

The present invention relates to a seed metering apparatus whose great differential is to provide a radial suction flow, that is, from a central point of the axle to its edge.

This particular characteristic provides a considerable reduction of internal friction, especially to its radial disc, directing the flow radially and consequently, perfectly sealing the holes as the seed are freely released from the seed meter, attracted by gravity.

A further outstanding characteristic of the radial suction-type seed metering apparatus is its exclusive seed organizer adjustable for each type of seed transported by the meter, as well as adjustments related to regular deteriorations caused by the time of use due to the soil's abrasiveness.

The radial suction-type seed metering apparatus also provides replacement of the radial disc, allowing its use for several different seeds, as example, soy beans, beans, sorghum, cotton seeds, among others, in which a specific type of disc is required to be used, based on the seed geometry and size.

### BRIEF DESCRIPTION OF THE SEVERAL VIEWS OF THE DRAWINGS

The foregoing and other objects, features and advantages of the invention will be apparent from the following more particular description of a preferred embodiment of the invention, as illustrated in the accompanying drawings, in which

FIG. 1 is a perspective view of the radial suction-type seed metering apparatus;

FIG. 2 is a front view of the radial suction-type seed metering apparatus;

FIG. 3 is an exploded perspective view of the radial suction-type seed metering apparatus;

FIG. 4 is a perspective view of the radial disc of the radial suction-type seed metering apparatus;

FIG. 5 is a side view of the radial suction-type seed metering apparatus showing cross-section details of “A” and “B” of the point in which there is an interruption of the negative pressure;

FIG. 6 is a view showing the radial suction-type seed metering apparatus installed in a planter row;

FIG. 7 is a top view showing the radial suction-type seed metering apparatus installed in a planter row; and

FIG. 8 is a side view of the planter.

### DESCRIPTION OF SPECIFIC EMBODIMENTS OF THE INVENTION

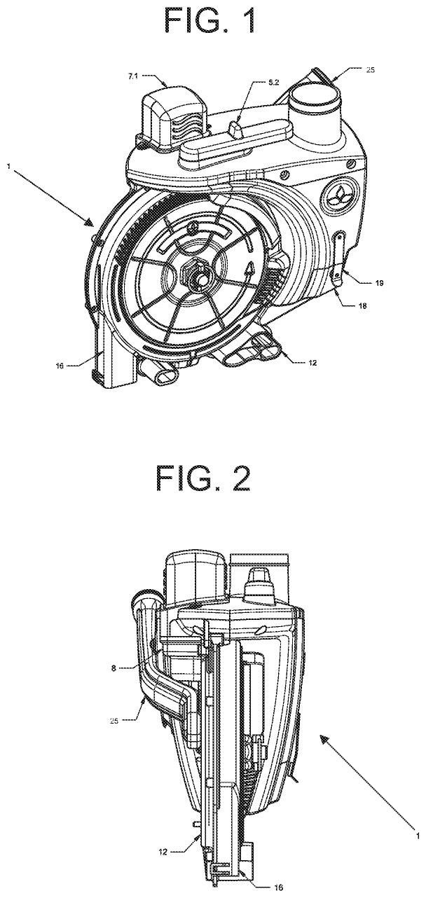

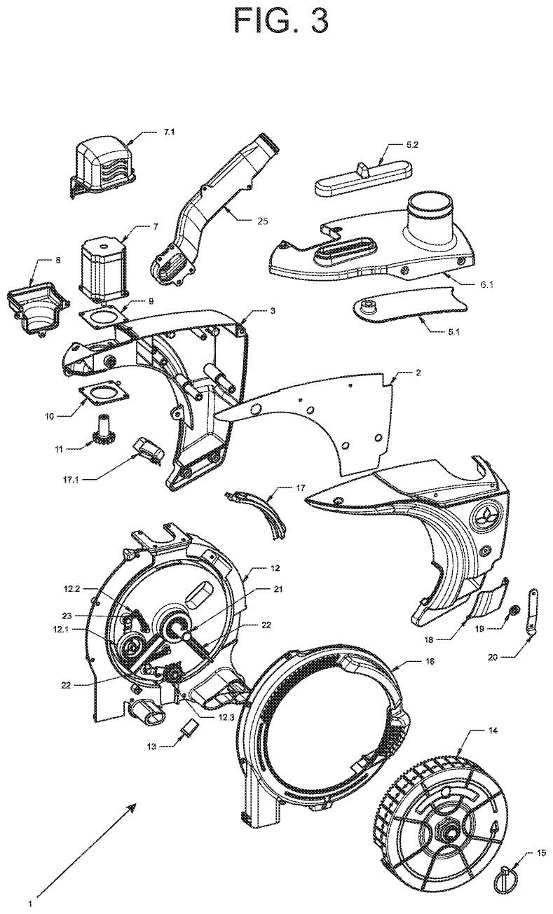

According to the brief description of the present invention for a “radial suction-type seed metering apparatus”, as illustrated in FIG. 1, shows a seed metering apparatus (1), which is part of an agriculture machine named planter (32) with the purpose of sowing crops. The mentioned seed metering apparatus (1) is installed in the planter (32) over the row planting, named seed row (31), working with negative pressure in relation to the atmospheric pressure, that is, vacuum generated by a central turbine (24) coupled to a hydraulic motor, being such negative pressure driven through ducts (25) between the central turbine (24) and the seed metering apparatus (1). The central turbine (24) can generate negative pressure to several seed rows (31). The negative pressure acts inside the seed metering apparatus (1) as the seed is driven to the metering (1) through a seed inlet duct (4) that connects the central seed reservoir (6) to the seed metering apparatus (1), being such reservoir (6) the central depository for all seed rows (31). The seeds are housed in the inner part of the seed metering apparatus (1), being pulled by negative pressure against the radial disc (14), which contains several holes halfway along its whole external area, in a way that the air suction passes through such holes, pulling and housing the seeds in the holes, that are organized by an adjustable seed organizer, in a way that only one seed remains in each hole.

The radial disc (14) is moved by an electric motor (7), which can be mechanically or hydraulically actuated. At point of the radial disc (14) of the seed metering apparatus (1), there is an interruption of the negative pressure by an elastic pulley (12.1) that rotates in the inner part of the radial disc (14) as the seeds are released from the radial disc (14), being pulled down by the gravity, passing through a duct that drives the seeds to the holes by the double disc of furrow opener discs (5).

The seed metering apparatus (1) provides a compact and robust construction, comprised by a central seed reservoir (6), back seed reservoir (3) and partition (2) thereof, seed inlet duct (4), top cover (6.1) of the back seed reservoir (3), regulation tray (5.1) of the central seed reservoir (6) outlet, actuation knob (5.2) of the regulation tray (5.1), electric motor (7) and the protection cover (7.1) thereof, protective cover (8) of the motor gear (11), upper sealing gasket (9), lower sealing gasket (10), motor gear (11), main housing (12), elastic pulley (12.1) for internal interruption of vacuum, bracket (12.2) of the elastic pulley (12.1), hole cleaning pulley (12.3), whose function is to keep all holes clean, allowing air inlet flow by negative pressure, cleaning brush (13) of the radial disc (14), holding ring pin (15) to the radial disc (14), front finishing cap (16), right seed scrapper (17), left seed scraper (17.1), seed outflow lid (18), bracket stop ring (19), fixing brackets (20) of the seed outflow lid (18), main axle (21), limiting brushes (22), traction spring (23).

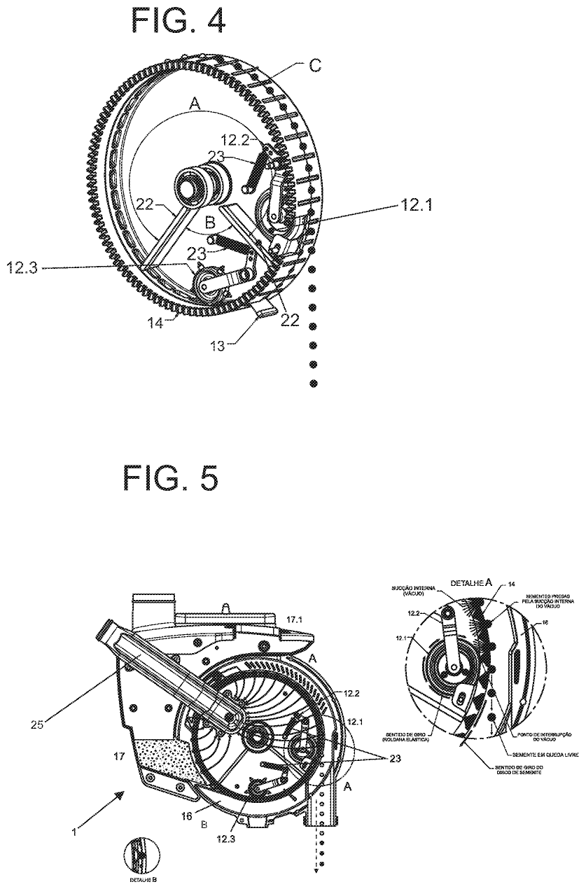

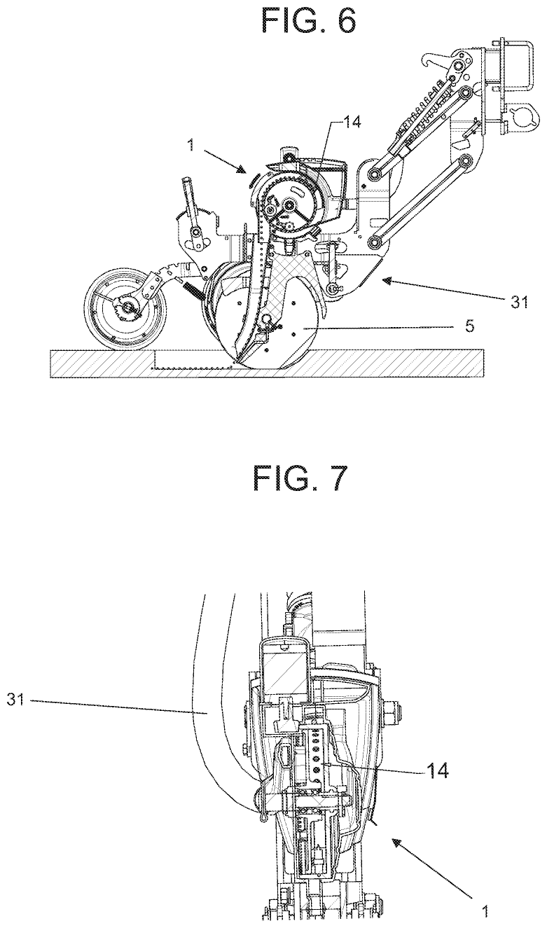

FIG. 4 shows the radial disc (14) containing cavity (C) to carry the seeds at the inner part of the back seed reservoir (3), as well as the elastic pulley (12.1), the limiting brushes (22) that separate the pressurized chamber (A) from the non-pressurized (B), the hole cleaning pulley (12.3), and the cleaning brush (13) of the radial disc (14).

FIG. 5 shows a side view of the seed metering apparatus (1), showing the direction of the suction flow, named “radial flow”, distinguishing the pressurized chamber (A), with negative pressure, from the non-pressurized chamber (B), as well as the seed release direction. Besides, it shows a view (“Detail A”) of the exact point of the negative pressure (vacuum) interruption, the elastic pulley (12.1), and the seed release point.

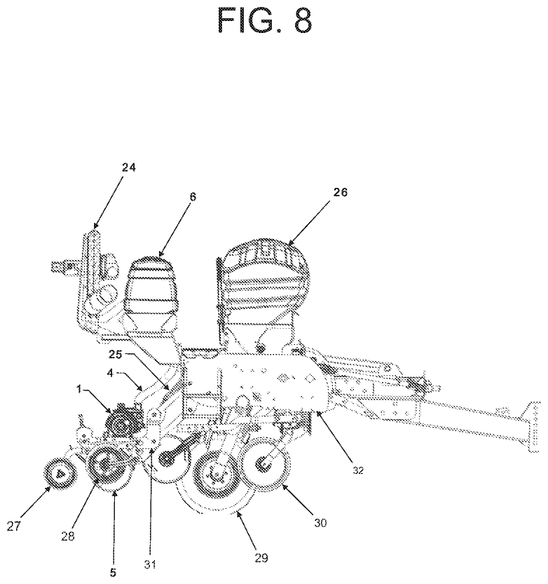

FIG. 8 shows the seed metering apparatus (1) installed over the seed row (31) with the suction connection thereof, seed inlet duct (4), pair of furrow opener discs (5), central seed reservoir (6), turbine (24), fertilizer reservoir (26), closing wheel (27), gauge wheel (28), planter tire (29), cutting disc (30)—these parts compounding the planter (32) that is trailed by a tractor.

The seed metering apparatus (1) is comprised by a back seed reservoir (3) and the partition (2) thereof, forming a reservoir set where the seeds are stored after coming from the central seed reservoir (6) through seed inlet duct (4). The back seed reservoir (3) has a top cover (6.1) thereon, which will close avoiding seeds release whenever maintenance is required. The regulation tray (5.1) for the outlet of the central seed reservoir (6) has the function of limiting the seed outlet.

The seed metering apparatus (1) has a actuation knob (5.2) on the top cover (6.1) of the back seed reservoir (3) to operate the tray (5.1), protection cover (7.1) of the electric motor (7), to activate the disc of seed distribution in rotation direction, and such disc has the function of carrying the seeds through the channels at the edge of the radial disc (14), taken them up to releasing the seeds where there is the elastic pulley (12.1) in the inner part of the seed disc.

One of the advantages of the seed metering apparatus (1) is its system of interruption of the negative pressure by the elastic pulley (12.1), which is made of a flexible material like elastomer. Its great differential compared to the pneumatic systems with axial suction is the level of friction to the radial disc (14), which is very low, perfectly sealing holes as the seeds are reliably released from the seed meter.

The present invention has an adjustable seed organizer, comprising a different adjustment for each type of seed, as well in the event of regular deterioration caused by the time of use due to seed abrasiveness. Another advantage of having an adjustable seed organizer is its easy-to-use characteristic, being simple, fast and economical during the time of use, since it will have a longer service life than a non-adjustable seed meter.

In addition, another advantage of the seed metering apparatus (1) is the easiness and fast way to prepare it to be used with other types of seeds, being only required a replacement of the radial disc (14); however, it is worth remembering that for each type of seed (for instance, maize, soy, bean, sorghum and cotton, etc.) a specific type of radial disc (14) is required due to the seed geometry and size. Besides, another advantage of the present invention is that it provides a multiple-actuator system, which may be electric, being actuated in the radial disc (14) itself or by the center of the main axle (21). It is also able to be mechanically actuated, either by spindle drive or by current, or hydraulically. Such diversification allows the user to acquire the seed metering apparatus (1) and substitute it in his planter (32) which has a mechanical seed distribution system.

It must be highlighted that the differential of the seed metering apparatus (1), when compared to other similar meters in the market, is the direction of the axial suction flow, which requires flat scrappers that usually apply friction to the seed disc in order to stop negative pressure suction since the scrappers are static and the disc is dynamic. Likewise, the seeds releases laterally by the seed disc experiencing friction and, consequently, route deviation—compromising the precision of the seed plantation.

In the system proposed herein, where the flow is radial suction-type, the interruption system of negative pressure is made by an elastic pulley (12.1) that, being supported by an axle, rotates with the radial disc (14) in the inner side, that is, there are two dynamic systems between them rotating clockwise and providing friction at the lowest level: elastic pulley (12.1) and radial disc (14). Likewise, since there is radial suction-type, no seed friction to the circumferential part occurs when they are released from the radial disc (14). So they are reliably released from the seed meter, leading to a better precision in plantation.

With connection to the conventional seed distribution mechanical-type systems, the advantage disclosed herein is the precision of plantation and distribution of seeds over the soil in a uniform row spacing, with no fails or double seeds, that is, the better the seed distribution over the soil, the greater is the productivity of farming per cultivated area.

It is to be understood that the present description does not limit the application of this invention to the details described herein, and that it is capable of being applied in other embodiments and to be practiced or performed in a variety of ways within the scope of the claims. Although specific terms have been used, such terms should be interpreted in a generic and descriptive sense, and not for the purpose of limiting them.

What is claimed is:

1. “RADIAL SUCTION-TYPE SEED METERING APPARATUS”, which is part of an agriculture machine named planter (32), comprising a seed metering apparatus (1), with radial suction flow, placed over the seed row (31), working with negative pressure in relation to the atmospheric pressure, that is generated by a central turbine (24) coupled to a hydraulic motor, being such negative pressure driven through ducts (25) between the central turbine (24) and the seed metering apparatus (1); such turbine (24) can generate negative pressure to several seed rows (31); the negative pressure works inside the seed metering apparatus (1) in a way that the seed is driven to the meter (1) through a seed inlet duct (4) that connects the central seed reservoir (6) to the seed metering apparatus (1) so that the seeds are housed in the inner part of the seed metering apparatus (1), being pulled by negative pressure against radial disc (14); such disc contains several holes halfway along its external area, in a way that the air suction passes through such holes, pulling and housing the seeds in the holes that are organized by an adjustable seed organizer, in a way that only one seed remains in each hole.

2. “RADIAL SUCTION-TYPE SEED METERING APPARATUS”, according to claim 1, wherein the radial disc (14) of the seed metering apparatus (1) is moved by an electric motor (7) and has an elastic pulley (12.1) that rotates in the inner part of such disc.

3. “RADIAL SUCTION-TYPE SEED METERING APPARATUS”, according to claim 2, wherein the elastic pulley (12.1) stops the negative pressure, releasing seed from the radial disc (14) being pulled down by the gravity, passing through a duct that drives the seeds to the holes by the double disc of furrow opener discs (5).

4. “RADIAL SUCTION-TYPE SEED METERING APPARATUS”, according to claim 1, wherein the seed metering apparatus (1) comprises a central seed reservoir (6), back seed reservoir (3) and the partition (2) thereof, seed inlet duct (4), top cover (6.1) of the back seed reservoir (3), regulation tray (5.1) of the central seed reservoir (6) outlet, actuation knob (5.2) of the regulation tray (5.1), electric motor (7) and the protection cover (7.1) thereof, protective cover (8) of the motor gear (11), upper sealing gasket (9), lower sealing gasket (10), motor gear (11), main housing (12), elastic pulley (12.1) for internal interruption of vacuum, bracket (12.2) thereof, hole cleaning pulley (12.3), whose function is to keep all holes clean, allowing air inlet flow by negative pressure, cleaning brush (13) of the disc of seed distribution, radial disc (14), holding ring pin (15) to the radial disc, front finishing cap (16), right seed scrapper (17), left seed scraper (17.1), seed outflow lid (18), bracket stop ring (19), fixing brackets (20) of the seed outflow lid (18), main axle (21), limiting brushes (22), traction spring (23).

5. “RADIAL SUCTION-TYPE SEED METERING APPARATUS”, according to claim 4, wherein the hole cleaning pulley (12.3) keeps all holes clean, allowing air inlet flow by negative pressure.

6. “RADIAL SUCTION-TYPE SEED METERING APPARATUS”, according to claim 2, wherein the radial disc (14) has cavity (C) to carry the seeds in the seed metering apparatus (1).

7. “RADIAL SUCTION-TYPE SEED METERING APPARATUS”, according to claim 2, wherein the radial disc (14) has limiting brushes (22) that separate the pressurized chamber (A) from the non-pressurized (B), the hole cleaning pulley (12.3), and the cleaning brush (13) of the radial disc (14) of seed distribution.

8. “RADIAL SUCTION-TYPE SEED METERING APPARATUS”, according to claim 4, wherein the central seed reservoir (6) comprises a back seed reservoir (3) and the partition (2) thereof, forming the seed reservoir set.

9. “RADIAL SUCTION-TYPE SEED METERING APPARATUS”, according to claim 8, wherein the seed inlet duct (4), from the central seed reservoir (6), is located sideway the seed metering apparatus (1).

10. “RADIAL SUCTION-TYPE SEED METERING APPARATUS”, according to claim 8, wherein the top cover (6.1) of the back seed reservoir (3) is located under the central seed reservoirs (6).

11. “RADIAL SUCTION-TYPE SEED METERING APPARATUS”, according to claim 10, wherein the top cover (6.1) of the back seed reservoir (3) avoids seeds release whenever maintenance is required.

12. “RADIAL SUCTION-TYPE SEED METERING APPARATUS”, according to claim 8, wherein the regulation tray (5.1) for the seed outlet from the central seed reservoir (6) limits the passage of seeds.

13. “RADIAL SUCTION-TYPE SEED METERING APPARATUS”, according to claim 4, wherein seed metering apparatus (1) has an actuation knob of the tray (5.2), electric motor (7), and protection cover (7.1) thereof.

14. “RADIAL SUCTION-TYPE SEED METERING APPARATUS”, according to claim 13, wherein the electric motor (7) activates the disc of seed distribution in rotation direction, carrying the seeds through the channels at the edge of the radial disc (14), carrying and releasing the seeds where there is an elastic pulley (12.1), located in the inner part of the seed disc.
